(19) United States
(12) Patent Application Publication
(10) Pub. No.: US 2013/0344789 A1
(43) Pub. Date: Dec. 26, 2013

(54) REMOTE HEATED AND COOLED COMPARTMENTS FOR AIRCRAFT GALLEYS

(71) Applicants: Thomas M. Lee, Coto De Caza, CA (US); Abdelaziz Boubeddi, Ashburn, VA (US)

(72) Inventors: Thomas M. Lee, Coto De Caza, CA (US); Abdelaziz Boubeddi, Ashburn, VA (US)

(21) Appl. No.: 13/974,167

(22) Filed: Aug. 23, 2013

Related U.S. Application Data
(63) Continuation-in-part of application No. 13/873,383, filed on Apr. 30, 2013.
(60) Provisional application No. 61/692,394, filed on Aug. 23, 2012.
(60) Provisional application No. 61/642,141, filed on May 3, 2012.

(51) Int. Cl. B64D 13/08; B64D 11/04

(52) U.S. Cl. CPC B64D 13/08; B64D 11/04
USPC 454/76; 165/41

(57) ABSTRACT

Embodiments of the present invention provide improved heating and/or cooling systems for aircraft galleys and other passenger transport vehicles, where meals are prepared. The embodiments are particularly designed to save space and in some instances, may lower the weight of the overall vehicle, by moving heat and cooled air generating components to a position remote from the compartment.

### CROSS REFERENCE TO RELATED APPLICATIONS

This application claims the benefit of U.S. Provisional Application Ser. No. 61/692,394, filed Aug. 23, 2012, titled “Galley Space Saving Solutions,” the entire contents of which are hereby incorporated by reference. This application is also a continuation-in-part of U.S. application Ser. No. 13/873,383, filed Apr. 30, 2013 titled “Integrated Galley with Improved Heating Systems” which claims the benefit of U.S. Provisional Application Ser. No. 61/642,141, filed May 3, 2012, titled “Integrated Galley,” the entire contents of each of which are hereby incorporated by reference.

### FIELD OF THE INVENTION

Embodiments of the present invention relate generally to integrated aircraft galleys that provide increased storage and counter space by incorporating improved meal heating and cooling systems in the galley area, without requiring changes in the existing aircraft catering processes for loading and serving meals.

### BACKGROUND

Aircraft galleys are different from traditional cooking kitchens, in that space is very limited and weight reduction is a high priority. Similar situations exist on private yachts, cruise ships, and other sea-going vessels, as well as motor homes, passenger trains, and other types of passenger transportation vehicles. Nonetheless, there are still instances when food preparation is necessary, and a high quality food product is expected.

In many aircraft (and other passenger transportation vehicle) galleys, it is useful to provide an oven that cooks or heats food products. These ovens may be bun warmers, microwaves, steam ovens, convection ovens, traditional ovens, and/or heating ovens with warming coils or plates, as well as any other types of heating systems, all of which are collectively referred to herein as “heating systems.” Use of such heating systems on-board aircraft or other transportation vehicles provides a quick, safe, and convenient method for cooking, heating, or re-heating various types of food products and meals.

Aircraft (and other passenger transportation vehicle) galleys also typically provide refrigeration units. These units are used to keep food to be served cold, as well as to cool beverages, such as coffee creamer and milk. These refrigeration units can have food loaded directly therein during the catering process. When it is time to cook/reheat the food for serving to passengers, the meal carriers may be removed from the refrigeration units and moved to ovens for heating.

However, providing one or more of these complete heating and cooling systems in the limited galley space area takes up valuable countertop space. Particularly if more than one heating system is required or if more than one type of heating system is installed in the galley, then each heating system has its own heat generator (typically at the back thereof), which takes up additional space. The heat generators may also be redundant, pulling additional power from the aircraft. Accordingly, improved heating solutions are needed for small spaces, such as aircraft galleys, where weight and space considerations are important. It is desirable that such solutions provide more integrated and efficient heating and/or cooling solutions.

### BRIEF SUMMARY

Embodiments of the present invention provide improved heating and cooling systems for aircraft galleys and other passenger transport vehicles, where meals are prepared. The embodiments are particularly designed to save space and in some instances, may lower the weight of the overall vehicle, by moving (and in some instances, consolidating) heat generating and cooling components to a position remote from the cooking cavity. In some embodiments, the heat generating and cooling components are positioned in or near the cabin galley ceiling; in other embodiments, the heat generating components may be positioned in other locations on the vehicle. For example, the components may be positioned in areas more remote from the galley. In one specific embodiment, the components may be positioned in the pressure dome area at the bulkhead in the aft of the aircraft. The cooking or cooling compartment is fluidly connected to one or more of the heat generating or cooling components via a ducting system, so that heat and/or steam and/or cool air can be delivered to the compartment.

### BRIEF DESCRIPTION OF THE DRAWINGS

FIG. 1 shows a front and side plan top plan view of one embodiment of a preparation galley in an aircraft.

FIG. 2 shows a front and side plan view of one embodiment of a high density galley in an aircraft.

FIG. 3 shows back perspective views of various embodiments of an aircraft galley wall having a remotely-located heat generator delivering heat to the cooking cavity via heating supply ducting.

FIG. 4 shows a side perspective view of one embodiment of a cooking cavity.

FIG. 5 shows a side perspective view of one embodiment of a meal carrier for use in connection with cooking cavity.

FIG. 6 shows a side perspective view of one embodiment of a standard container for use in an aircraft galley.

FIG. 7 shows a side perspective view of one embodiment of a standard trolley for use in an aircraft galley.

FIG. 8 shows a side perspective view of one embodiment of an aircraft galley with multiple heat generators positioned in dead space corner areas.

FIG. 9 shows a front plan view of multiple cooking cavities with doors closed.

FIG. 10 shows a front plan view of FIG. 9 with the cavity doors removed.

FIG. 11 shows a side perspective view of the pressure bulkhead area of an aircraft.

FIG. 12 shows a side cross sectional view of the aft galley and how unused space from the bulkhead may be used to house heat and/or cooled air generators.

### DETAILED DESCRIPTION

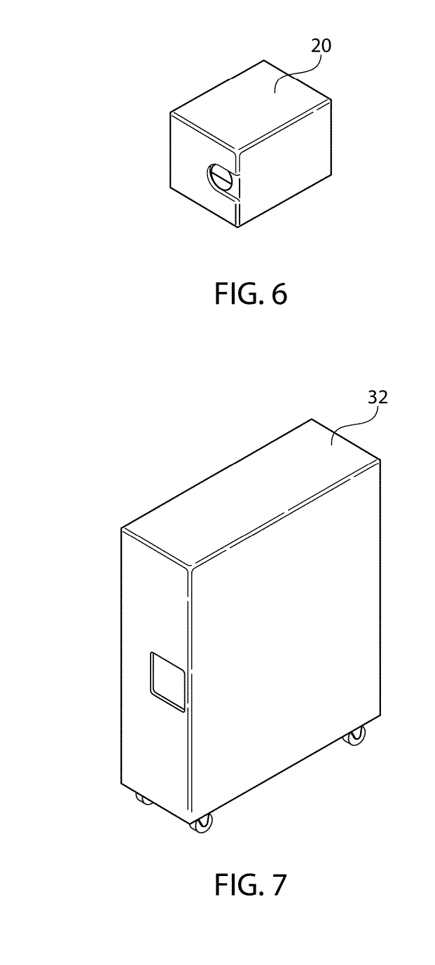

Embodiments of the invention described herein thus provide a compartment 12 (or cavities) that is (are) positioned remotely from the heat generator portion(s) 16 and/or cooling elements or generators 16. (The term “generator” is used herein to refer generally to a heat generator or a cooled air generator, and it is intended to encompass the various components necessary for generating heated air or cooled air. The term “compartment” is used herein to refer to an internal portion of an oven or a heating device or an internal portion of a cavity that can receive cooled or heated air in order to contain the contents in a cooled or heated state, and generally includes an insulated liner only, and does not include any of the other heating or cooling components that are traditionally associated with an oven or heating unit or a refrigeration unit.) The compartment 12 may be formed as a vacuum insulated stainless steel liner, with an insulating material surrounding the liner, and an outing casing. One example of a compartment 12 is shown in FIG. 4. In a specific embodiment, the cooking cavity is designed to contain one or more meal carriers 14 (an example of which is shown in FIG. 5), which contain meals for consumption on-board the vehicle. During the catering process, the meal carriers are generally loaded directly into the compartment when the cavity is not warmed or heated. In the image shown, it is expected that up to two or three meal carriers may be positioned lengthwise in a single compartment 12. During this time in the catering process, it is desirable to maintain the meals at a refrigerated temperature to prevent spoiling. Cooled air from a cooling system may be directed toward the compartment 12 to maintain the meals at the desired temperature. When the catering process is to begin, heat from the heat generator is directed toward the compartment.

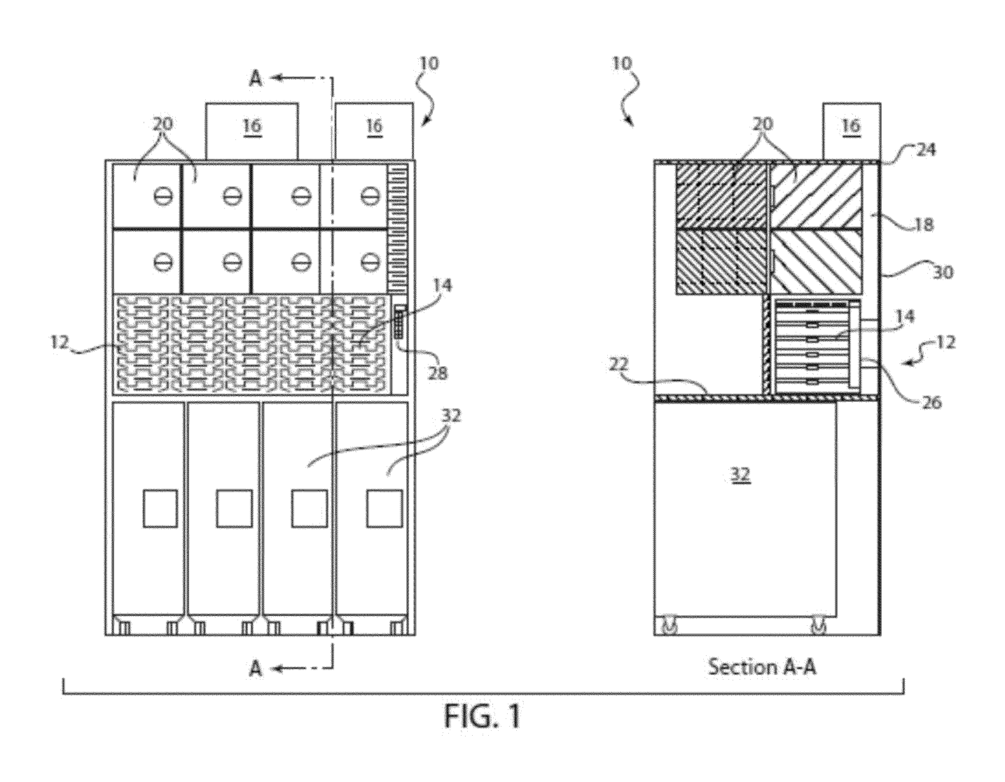

As shown in FIG. 1, which illustrates an aircraft preparation galley 10, a compartment 12 is generally positioned at countertop level. This figure shows the cavity 12 having a plurality of meal carriers 14 positioned therein. A traditional refrigerating unit would typically require a large amount of space underneath the counter due to the cooling components associated with the refrigerator, which are typically positioned at the back of the unit. A traditional oven or other heating system would require a large amount of counter space due to the heating components associated with the oven, which are typically positioned at the back of the oven. However, the present inventors have moved all functioning and other components of the cooling and heating systems away from the lower area and countertop area, and positioned them remotely from the compartment 12. For example, one or more heat generators 16 and/or cooling generators 16 are positioned at an upper area of the galley 10. (The term “heat generator” is used herein to refer to any of the heating components or elements that are used to generate heat and/or steam for cooking, heating, and/or re-heating food items or meals. The term includes but is not limited to heating coils, blowers, steam generators, power supplies, any other appropriate heat generating components, or any combination thereof. The term “cooling generator” similarly refers to any of the cooling component or elements that are used to generate cooked air that can be delivered to the compartment and blown over the meals contained therein.) It is also possible for the systems described herein to be implemented in connection with a cooling system for a refrigerator or other cooling unit. The location and descriptions of the heat generator throughout this document are similarly applicable to cooling systems.

It is possible to provide one or more of a convection heat generator, an induction heater, a steam heat generator, a radiation heat generator, or any other combination of heat generators desired. A single heat generator may be provided (which may be used to deliver heat to a single or multiple cooking cavities) or multiple heat generators may be provided to deliver various different types of heat or additional forms of the same type of heat to one or more cooking cavities. It is also possible to provide one or more universal heat generators designed to create various types of heat desired in a single unit. It is also possible to provide a cooling unit or one or more universal cooling generators designed to create various types of cooled air as well.

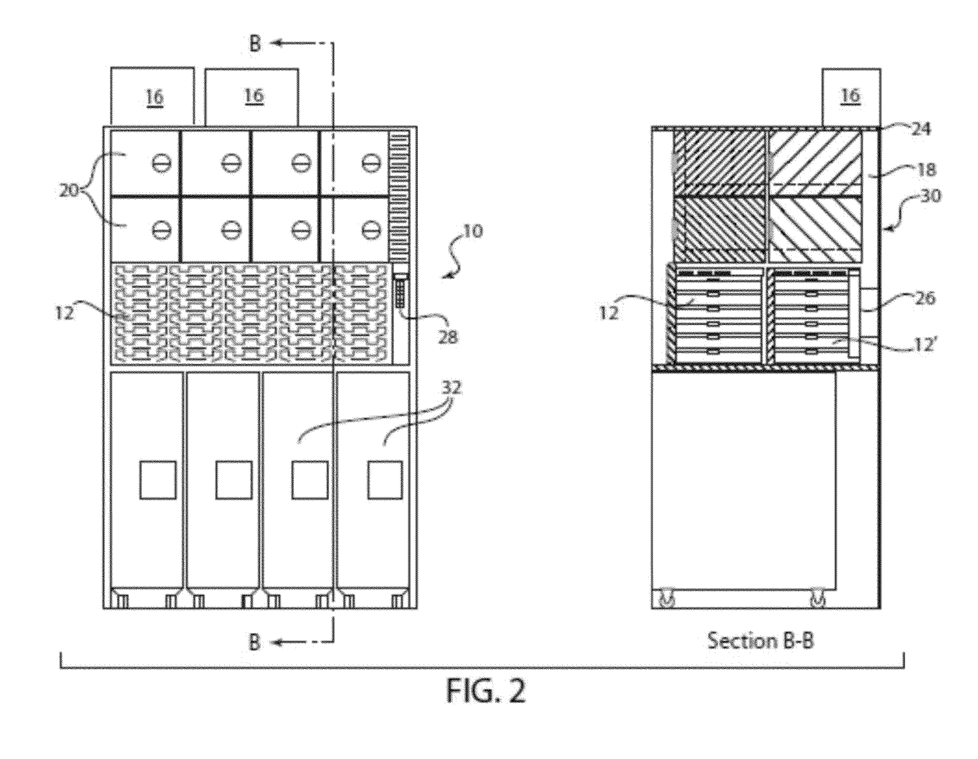

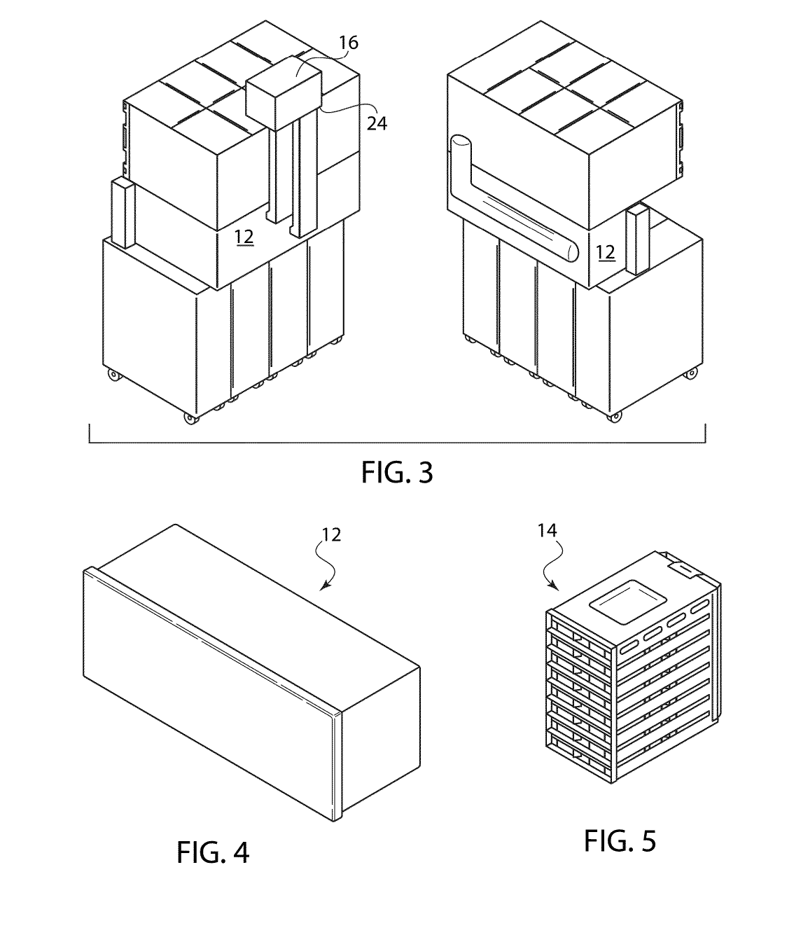

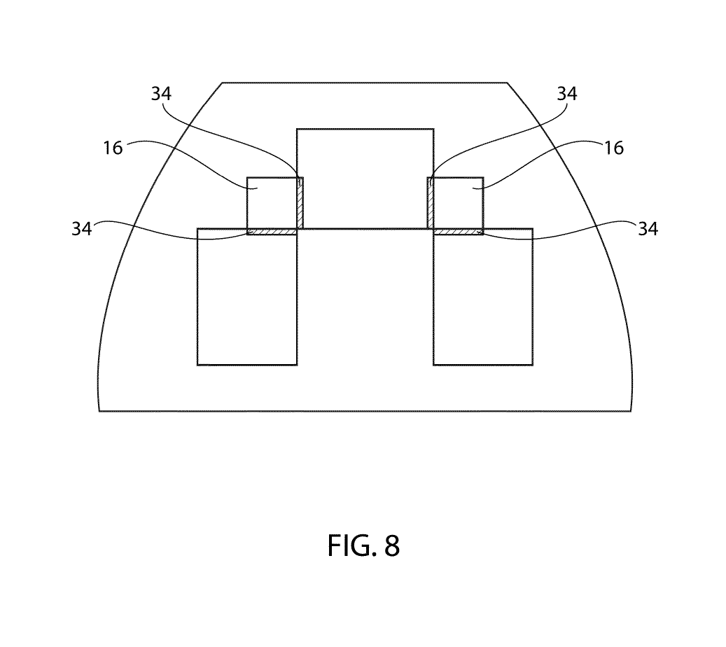

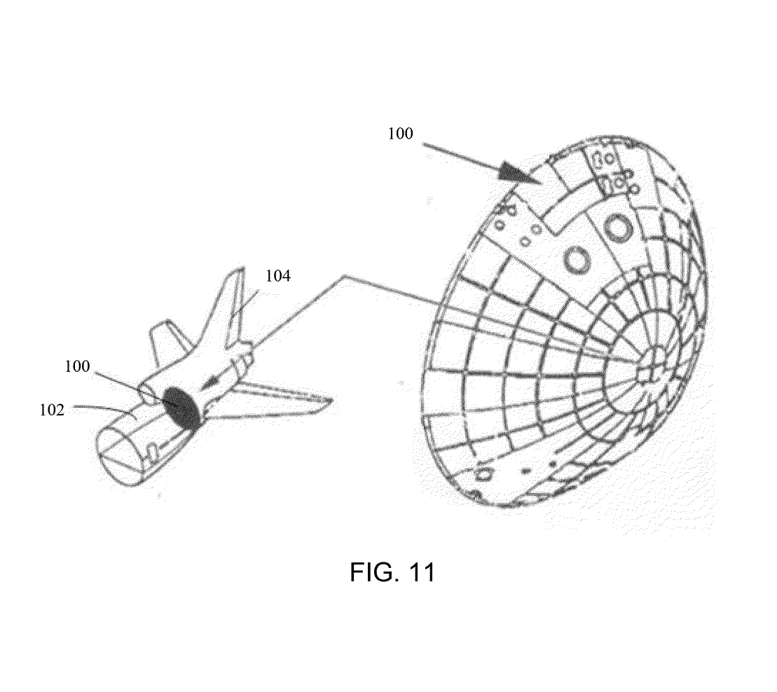

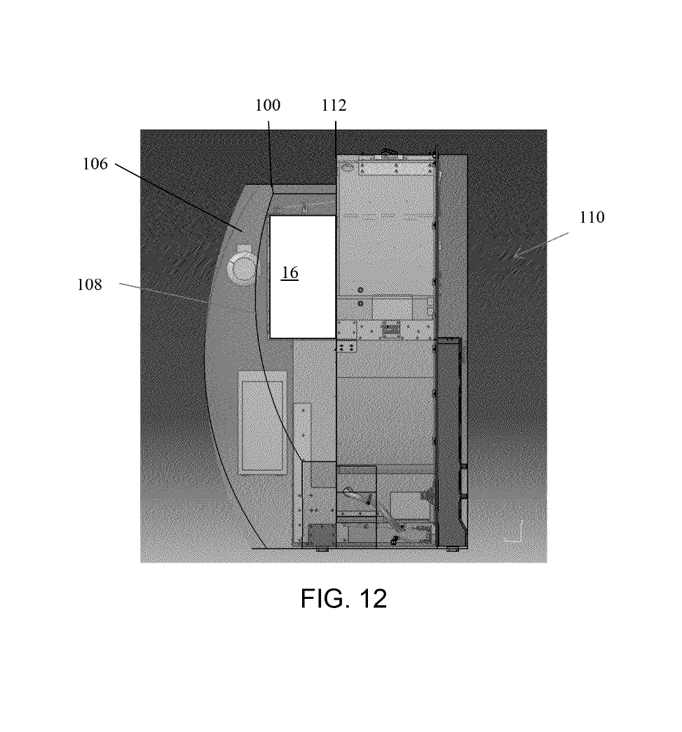

Instead of being positioned above the galley cabinet area as shown in FIGS. 1 and 2, the heat generator(s) 16 may alternatively be positioned in an alternate space, such as in the space allotted for one or more of the containers 20, in one of the lower trolleys 32, in a dead area of the galley, such as one or more of the corners which are typically unused, in one of the closets, below the galley floor, below the passenger desk elsewhere on the aircraft, or any other area where there is unused or dead space in the galley or in the aircraft. In fact, it is possible to locate the heat generator(s) 16 even further from the galley, or any other desired area, as long as the ducting is sufficiently long and sufficiently insulated to deliver the heat to the compartment 12. One example of a heat generator 16 positioned in a corner cavity of a galley area is shown by FIG. 8. Access to the heating generator unit 16 is provided at one or more points 34 behind or beneath the heating unit 16. Another potential location for the heat generator and cooling system is to be positioned in the pressure bulkhead at the aft of the aircraft. For example, as shown in FIG. 11, the the aft pressure bulkhead 100 (also referred to as the rear pressure bulkhead) is a component of all large commercial aircraft. It is an airtight bulkhead located between the cabin 102 and the tail 104 of the aircraft. Its purpose is to seal the rear of the aircraft and thus maintain cabin pressure via a pressure dome 106, as shown in FIG. 12. The aft pressure bulkhead 100 is a vital part of the aircraft, and is generally present on all aircraft. However, although the pressure bulkhead 100 is necessary on the aircraft for safety and technical reasons in order to manage pressure and load, there is also unused space 108 in the pressure bulkhead 100, illustrated by FIG. 12. Aircraft design has been such that a forward-facing galley 110 is traditionally positioned at the aft of aircraft, directly in front of the pressure bulkhead 100. This is, in part, in order to cover the pressure bulkhead 100. However, the back walls 112 of these galleys have not monopolized on this unused space 108. It is possible to provide the heating and cooling generators 16 and components into space 108 and duct them heated or cooled air to compartments that may be positioned in the aft galley 110. The heat and/or cooling generator 16 is generally associated with insulated ducting 18 that is used to deliver the generated heat or cooled air to the compartment 12. Examples of various configurations of ducting are shown in FIG. 3, and may depend upon whether one or more cooking cavities 12 are being supplied with heat or cooled air. FIG. 3 shows ducting 18 used to deliver air from a remotely-located generator 16 to a compartment 12. Ducting 18 allows the heat/cooling generator 16 to be located in a remote location, i.e., away from the compartment 12 and not directly connected thereto or associated therewith, but to deliver the heat/cooled air generated at the remote location to the compartment 12 for cooling/warming/heating/cooking The ducting 18 may be secured to the heat/cooling generator 16 and the compartment 12 via any appropriate connection method. It generally provides a channel to conduct and deliver heat and/or steam and/or cooled air. The heating supply ducting 18 may be manufactured out of an insulated ducting material.

FIG. 1 illustrates a heat generator 16 (and/or a cooling generator) positioned above a set of containers 20. Although for the sake of convenience only one generator 16 is shown, it is generally understood that at least two generators will be necessary, one for creating cooled air and one for generating heat. Each generator will generally have its own individual ducting 18 connecting the generator to the compartment 12. The generators 16 may ultimately deliver the desired temperature of air or steam to the compartment 12 at the desired time, depending upon when a cooling setting or heating setting has been selected. The containers 20 above which the generator(s) 16 is/are positioned may generally be standard Atlas containers, and they are used for storage and containing items in an aircraft galley, much like traditional cabinets. One example of a particular container is shown in FIG. 6. The space above these containers 20 in a traditional galley generally goes unused, so by re-positioning the heat generator 16 to this location, additional space can be garnered, for example, for additional countertop space 22 and additional cabinets 20. This additional countertop space 22 and cabinet space is created by moving the heat/cooling generator to the remote location. The Section A-A of FIG. 1 and Section B-B of FIG. 2 illustrate the ducting 18 that leaves the heat generator 16 at a generator connection point 24, travels along a back wall of the galley 30, and delivers the heat and/or steam and/or cooled air to the compartment 12 via a compartment inlet/connection point 26.

Space is also maximized in the current design because the compartment does not need as much clearance around it (for safety reasons and regulations), because the heat is being generated remotely. The remotely-located heat generator 16 may need the appropriate clearances for cooling and air circulation, but this does not take up valuable space at the galley countertop level. This system also eliminates the required clearances and keeps only the inner cavity (the insulated cooing cavity portion) in the central galley area, which results in freeing galley space that can be used for more cooking and storage space. Additionally, as a result, space in the aircraft cabin can be saved by eliminating, for example, up to even one galley, depending of the size of the aircraft.

When the chilling function is to be used, the central controller 28 is set to a cold setting, such that cooled air will be generated and delivered to the compartment. When the oven is to be used, the central controller 28 is activated to the desired setting. (The provided settings will generally be the traditional oven settings available, such as warm, steam, bake, convection, roast, broil, and so forth). Activation of the controller 28 causes the heat generator 16 to begin generating heat, which may be in the form of hot air and/or steam which is directed to the compartment 12 via the ducting 18. The cooling function is stopped and the individual meals in the meal carriers (one example of which is shown in FIG. 5) are then heated to the desired temperature for serving.

In an alternate or additional embodiment, the heat generator 16 may include an insulated water hose that connects the heat generator 16 with a beverage maker. This allows the heat generator to heat water that can be delivered to the beverage maker, such that the beverage maker can similarly pull heat from the remote location, saving space and possibly saving energy. In this embodiment, there may be a water reservoir provided near the heat generator 16 in the remote location to either deliver water to the heat generator and/or to contain heated water.

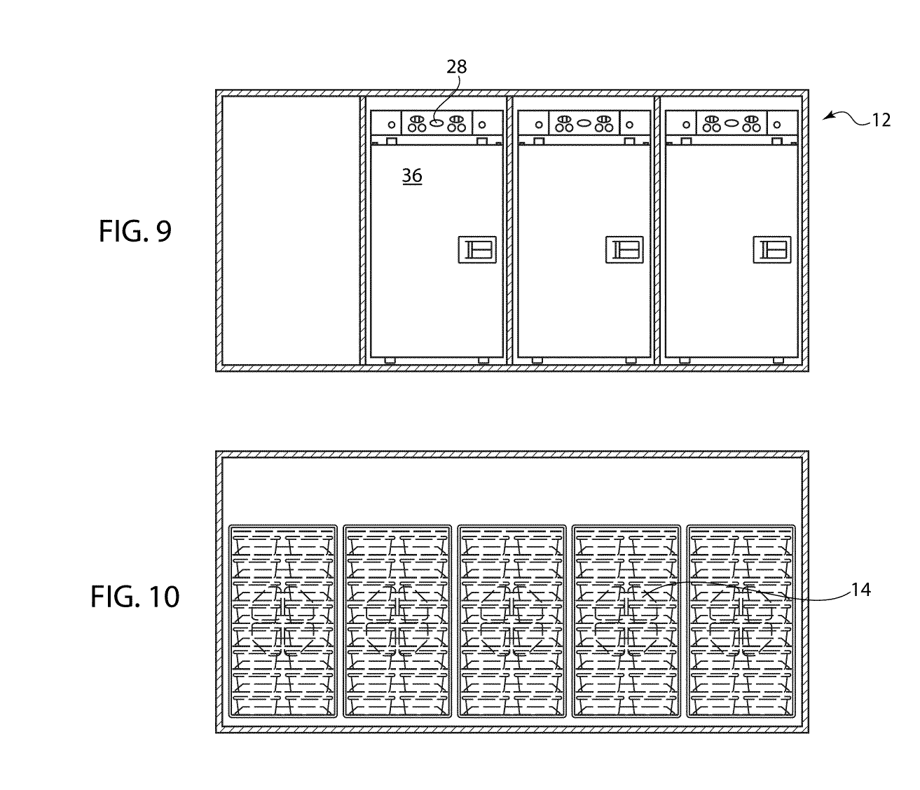

FIG. 2 shows an alternate configuration, with two sets of cooking cavities 12 and 12′ positioned in a high density galley. This galley configuration is possible when countertop space is not needed or is otherwise provided elsewhere. This configuration can allow twice as many meals to be cooked. FIGS. 9 and 10 also illustrate a high density galley with more than one compartment 12. FIG. 9 illustrates the cavities with oven doors 36 closed, and FIG. 10 illustrates the same configuration with the oven doors removed and with meal carriers 14 in place in the cavities 12. Again, by providing the heat generator 16 at a remote location, more cooking cavities may be positioned at the countertop level. Although two cooking cavities are shown in FIG. 2, it should be understood that more cavities may be provided, either stacked upon one another or in a side-by-side configuration (as shown by FIGS. 9-10). The multiple cooking cavities 12 may pull heat from a single heat generator 16 or from more than one heat generators as needed.

FIGS. 1-2 and 7 also illustrate the trolleys 32 that are generally positioned below the countertop area in the galley. These trolleys 32 are particularly useful on longer flights, where a first set of meals is loaded in to the compartment 12 and a second set of meals may be loaded into the trolleys 32 for a second meal consumption many hours later. (Trolleys may also contain other components such as trash compactors or other trash collections areas; they may be drink or snack trolleys, or may be used for any other service cart usage.)

Alternatively, it is possible to provide a second set of one or more compartments 12, such that food in the second set of compartments can be set to the cool setting and be chilled, while meals in the first set of one or more compartments 12 are being heated for service to passengers. This system could potentially alleviate the need for trolleys/chillers that are used solely to chill food until service time and that are empty once the food has been transferred to the ovens.

Changes and modifications, additions and deletions may be made to the structures and methods recited above and shown in the drawings without departing from the scope or spirit of the invention and the following claims.

What is claimed is:

1. A remote heating and cooling system for use in an aircraft galley, comprising:
A compartment;
A heat generator positioned remotely from the compartment;
A cooling generator positioned remotely from the compartment;
A first ducting system fluidly connecting the compartment and the cooling generator in order to deliver generated cooled air to the compartment during a first cooling process; and
A second ducting system fluidly connecting the compartment and the heat generator in order to deliver generated heat to the compartment during a second heating process.

2. The system of claim 1, wherein the heat generator is positioned in an empty space above galley components.

3. The system of claim 1, wherein the cooling generator is positioned in an empty space above galley components.

4. The system of claim 1, wherein the heat generator is positioned in a pressure bulkhead at the aft of the aircraft.

5. The system of claim 1, wherein the cooling generator is positioned in a pressure bulkhead at the aft of the aircraft.

6. The system of claim 1, wherein the heat generator comprises a heater, a blower, a steam generator, a power supply, or any combination thereof.

7. The system of claim 1, wherein the ducting system comprises insulated ducting for heat and steam and cooled air transfer.

8. The system of claim 1, wherein the compartment is a double-walled vacuum insulated compartment.

9. The system of claim 1, wherein the compartment is configured to receive one or more aircraft meal carriers.

10. The system of claim 1, wherein the heating system does not require any changes to current catering processes.

11. A system configured for installation in an aircraft cabin galley to remotely heat and cool meal carriers, comprising:
A compartment configured to receive one or more aircraft meal carriers;
A heat generator positioned above galley components and remotely from the compartment;
A cooling generator positioned above galley components and remotely from the compartment;
A first ducting system comprising insulated ducting for cooled air transfer fluidly connecting the compartment and the cooling generator in order to deliver generated cooled air to the compartment;
A second ducting system comprising insulated heating supply ducting for heat and steam transfer fluidly connecting the compartment and the heat generator in order to deliver generated heat to the compartment.

12. The system of claim 11, wherein the heat generator comprises a heater, a blower, a steam generator, a power supply, or any combination thereof.

13. The system of claim 11, further comprising an insulated hot water hose connecting the heat generator with a beverage maker.

14. The system of claim 11, wherein the compartment is a double-walled vacuum insulated compartment.

15. The system of claim 11, wherein the heating system does not require any changes to current aircraft catering processes.

16. The system of claim 11, wherein the cooling generator, the heat generator, or both are positioned in an empty space above galley components.

17. The system of claim 11, wherein the cooling generator, the heat generator, or both are positioned in a pressure bulkhead at the aft of the aircraft.
